(19) United States
(12) Patent Application Publication
(10) Pub. No.: US 2026/0001118 A1
(43) Pub. Date: Jan. 1, 2026

(54) A UNITARY BUMPER BEAM ASSEMBLY FOR A VEHICLE

(71) Applicant: AUTOTECH ENGINEERINC S.L., Amorebieta-Etxano (ES)

(72) Inventors: Antoni BÉCARES LOPEZ, Santpedor, Barcelona (ES); David RIBALTA MACIÀ, Sant Joan de Vilatorrada, Barcelona (ES); Alfredo SESÉ CERVERO, Esplugues de Llobregat, Barcelona (ES)

(21) Appl. No.: 18/880,541

(22) PCT Filed: Jul. 4, 2023
(86) PCT No.: PCT/EP2023/068468

§ 371 Date: Dec. 31, 2024

(30) Foreign Application Priority Data
Jul. 7, 2022 (EP) 22382650.4

(51) Int. Cl. B21D 53/88; B21D 22/02; B21D 35/00; B60R 19/12; B60R 19/18

(52) U.S. Cl. CPC B21D 53/88; B21D 22/022; B21D 35/006; B60R 19/12; B60R 19/18; B60R 2019/1826

(57) ABSTRACT

The present disclosure relates to methods for manufacturing a unitary a bumper beam assembly of a vehicle. The method comprises providing a plurality of blanks, joining the blanks to each other to form a combined blank, and deforming the combined blank to form the unitary bumper beam assembly. The unitary bumper beam assembly includes a bumper beam, a pedestrian beam and at least one bracket connecting the bumper beam to the pedestrian beam. The plurality of blanks comprises a bumper beam blank and a pedestrian beam blank, and joining the blanks comprises forming one or more overlapping regions formed by partially overlapping the blanks with each other. The present disclosure further relates to unitary bumper beam assemblies obtainable by such methods.

### The present application claims the benefit of EP22382650.4 filed on Jul. 7, 2022.

The present disclosure relates to unitary bumper beam assemblies for vehicles and methods of manufacturing unitary bumper beam assemblies for vehicles.

### BACKGROUND

Vehicles such as cars incorporate a structural skeleton designed to withstand all loads that the vehicle may be subjected to during its lifetime. The structural skeleton is further designed to withstand and absorb impacts, in case of e.g. collisions with other cars, obstacles or pedestrians.

The structural skeleton of a vehicle, e.g. a car, in this sense may include e.g. bumpers, pillars (A-pillar, B-pillar, C-pillar, D-pillar), side impact beams, rockers or sills, hinge pillars and shock absorbers.

One of the structures which plays a role in the protection of the vehicle in case of a frontal or rear impact is the bumper beam. A bumper may generally comprise a bumper beam (i.e. a transverse beam made of high strength material which is the main structural part of the bumper), and a cover and absorber structure (which is usually made of plastics).

The main function of the bumper beam is the protection of the vehicle and its occupants. The bumper beam is an energy-absorbing part that protects the vehicle body in the event of a crash. A front bumper beam is usually connected to the front rails by a crash box. Accordingly, deformation of the front rails may only occur when the energy absorption capacity of the bumper beam and crash-box is exceeded.

Additionally, vehicles may comprise a lower bumper beam, also known as pedestrian beam, at the front end. The pedestrian beam may be joined to the bumper beam through vertical brackets to form a bumper beam assembly. While the bumper beams are energy-absorbing parts that protect the vehicle body in the case of a collision, the lower bumper beams or pedestrian beams are the part of the bumper beam assembly which aims to ensure pedestrian safety.

The bumper beam and the pedestrian beam have different functionalities; therefore, they are usually made of different materials and they can be manufactured differently.

The upper beam is a part with a desired high stiffness, achieved generally by hot stamping (“press hardening”) which aims to limit the intrusion in the case of impact at a relatively low weight. The pedestrian beam is a member joined to the bumper beam directed to the protection of the pedestrian in case of an impact. Thus, the pedestrian beam may be a softer part. It is usually less thick than the bumper beam and is typically made of a material suitable for cold stamping.

Press hardening, also known as Hot Forming Die Quenching (HFDQ) typically uses boron steel sheets to create stamped components with Ultra High Strength Steel (UHSS) properties, with tensile strengths of e.g. 1.500 MPa or 2.000 MPa or even more. The increase in strength allows for a thinner gauge material to be used, which results in weight savings over conventionally cold stamped mild steel components. Throughout the present disclosure UHSS may be regarded as a steel having an ultimate tensile strength of 1.000 MPa or more after a press hardening process.

In a HFDQ process, a blank to be hot formed may be heated to a predetermined temperature e.g. austenization temperature or higher (and particularly between Ac3 and an evaporation temperature of e.g. a coating of the blank). A furnace system may be used for this purpose. Depending on the specific needs, a furnace system may be complemented with additional heaters, e.g. induction or infrared. By heating the blank, the strength of the blank is decreased and deformability increases i.e. to facilitate the hot stamping process.

There are several known Ultra High Strength steels (UHSS) for hot stamping and hardening. The blank may be made e.g. of a boron steel, coated or uncoated, such as Usibor® (22MnB5) commercially available from ArcelorMittal.

Usibor® 1500P is an example of a 22MnB5 steel. The composition of Usibor® is summarized below in weight percentages (rest is iron (Fe) and impurities):
Maximum carbon (C) (%): 0.25
Maximum silicon (Si) (%): 0.4
Maximum manganese (Mn) (%): 1.4
Maximum phosphorus (P) (%): 0.03
Maximum sulphur(S) (%): 0.01
Aluminium (Al) (%): 0.01-0.1
Maximum titanium (Ti) (%): 0.05
Maximum niobium (Nb) (%): 0.01
Maximum copper (Cu) (%): 0.20
Maximum boron (B) (%): 0.005
Maximum chromium (Cr) (%): 0.35

Usibor® 1500P may have a yield strength of e.g. 1.100 MPa, and an ultimate tensile strength of 1.500 MPa.

Usibor® 2000 is another boron steel with even higher strength. The yield strength of Usibor® 2000 may be 1.400 MPa or more, and the ultimate tensile strength may be above 1.800 MPa. The composition of Usibor® 2000 is summarized below in weight percentages (rest is iron (Fe) and impurities):
Maximum carbon (C) (%): 0.36
Maximum silicon (Si) (%): 0.8
Maximum manganese (Mn) (%): 0.8
Maximum phosphorus (P) (%): 0.03
Maximum sulphur(S) (%): 0.01
Aluminium (Al) (%): 0.01-0.06
Maximum titanium (Ti) (%): 0.07
Maximum niobium (Nb) (%): 0.07
Maximum copper (Cu) (%): 0.20
Maximum boron (B) (%): 0.005
Maximum chromium (Cr) (%): 0.50
Maximum molybdenum (Mb) (%): 0.50

As mentioned before, Hot Forming Die Quenching may also be called “press hardening” and also the term “hot stamping” may be used. These terms will be used interchangeably throughout the present disclosure.

Typical vehicle components that may be manufactured using the HFDQ process include: door beams, bumper beams, cross/side members, A/B pillar reinforcements, front and rear rails, seat crossmembers and roof rails.

Hot forming of boron steels is becoming increasingly popular in the automotive industry due to their excellent strength and formability. Many structural components that were traditionally cold formed from mild steel are thus being replaced with hot formed equivalents that offer a significant increase in strength. This allows for reductions in material thickness (and thus weight) while maintaining the same strength.

In order to improve the ductility and energy absorption in specific areas of a component, it is known to introduce softer regions within the same component. This improves ductility locally while maintaining the required high strength overall. By locally tailoring the microstructure and mechanical properties of certain structural components such that they comprise regions with very high strength (very hard), i.e. high ultimate tensile strength and high yield strength and regions with increased ductility (softer), i.e. lower ultimate tensile strength and lower yield strength and increased elongation before break, it may be possible to improve their overall energy absorption and maintain their structural integrity during a crash situation and also reduce their overall weight. Such soft zones may also advantageously change the kinematic behavior in case of a collapse of a component under an impact.

Known methods of creating regions with increased ductility (“softzones” or “soft zones”) in structural components of vehicles include the provision of tools comprising a pair of complementary upper and lower die units, each of the units having separate die elements (steel blocks). A blank to be hot formed is previously heated to a predetermined temperature e.g. austenization temperature or higher by, for example, a furnace system so as to decrease the strength i.e. to facilitate the hot stamping process.

The die elements may be designed to work at different temperatures, in order to have different cooling rates in different zones of the part being formed during the quenching process, and thereby resulting in different material properties in the final product e.g. soft areas which will generally have a lower ultimate tensile strength and a lower yield strength, but allow for more elongation before breaking. E.g. one die element may be cooled in order to quench the corresponding area of the component being manufactured at high cooling rates and to thereby reduce the temperature of the component rapidly and obtain a hard martensitic microstructure. Another neighboring die element may be heated in order to ensure that the corresponding portion of the component being manufactured cools down at a lower cooling rate, in order to obtain a softer microstructure, including e.g. bainite, ferrite and/or perlite. Such an area of the component may remain at higher temperatures than the rest of the component when it leaves the die.

Other methods for obtaining hot stamped components with areas of different mechanical properties include e.g. tailored or differentiated heating prior to stamping, and local heat treatments after a stamping process to change the local microstructure and obtain different mechanical properties. Yet further possibilities include the use of patchwork blanks, and Tailor Welded Blanks (TWB) combining different thicknesses and/or materials in blanks.

UHSS may exhibit tensile strengths as high as 1.500 MPa, or even 2.000 MPa or more, particularly after a press hardening operation. Once hardened, a UHSS may have a martensitic microstructure. This microstructure enables an increased maximum tensile and yield strength per weight unit.

In addition to the Ultra High Strength Steels mentioned before, more ductile steels may also be used in parts of the structural skeleton requiring energy absorption. These steels may be used in hot stamping processes but will not obtain a martensitic microstructure in the process. Examples of suitable, more ductile steels include Ductibor® 500, Ductibor® 1000 and CRL-340LA.

Another material used in hot stamping is Ductibor® 500. Ductibor® 500 is a steel material with much higher ductility and these can be effective for absorbing energy during an impact. The yield strength of Ductibor® 500 may be 400 MPa or more, and the ultimate tensile strength of 550 MPa or more.

The composition of Ductibor® 500 is summarized below in weight percentages (rest is iron (Fe) and impurities):
Maximum carbon (C) (%): 0.1
Maximum silicon (Si) (%): 0.5
Maximum manganese (Mn) (%): 1.7
Maximum phosphorus (P) (%): 0.03
Maximum sulphur(S) (%): 0.025
Aluminium (Al) (%): 0.015-0.2
Maximum titanium (Ti) (%): 0.09
Maximum niobium (Nb) (%): 0.10
Maximum copper (Cu) (%): 0.20
Maximum boron (B) (%): 0.001
Maximum chromium (Cr) (%): 0.20

Ductibor® 1000 is another material used in hot stamping for increasing the elongation if compared to Usibor® 1500 and Usibor® 2000. The yield strength of Ductibor® 1000 may be 800 MPa or more, and the ultimate tensile strength of 1000 MPa or more. The composition of Ductibor® 1000 is summarized below in weight percentages (rest is iron (Fe) and impurities):
Maximum carbon (C) (%): 0.10
Maximum silicon (Si) (%): 0.6
Maximum manganese (Mn) (%): 1.8
Maximum phosphorus (P) (%): 0.03
Maximum sulphur(S) (%): 0.01
Aluminium (Al) (%): 0.01-0.1
Maximum titanium (Ti) (%): 0.05
Maximum niobium (Nb) (%): 0.10
Maximum copper (Cu) (%): 0.20
Maximum boron (B) (%): 0.005
Maximum chromium (Cr) (%): 0.20

Since the requirements of each part are so different, the bumper beam assembly is generally produced in several components. Generally, a bumper beam assembly may be formed by hot stamping a bumper beam blank, cold stamping a pedestrian beam blank. After the respective forming processes, the beams may be connected to each other through vertical brackets. The brackets may be welded to both the bumper beam and the pedestrian beam. Accordingly, bumper beam assemblies may be formed by welding together e.g. four separate stamped pieces. Welding is usually done by metal active gas (MAG).

One problem that has been encountered is that the several welding spots and seams can lead to vulnerable parts in collision. Weight, manufacturability and cost are also issues to be considered.

The present disclosure provides examples of systems and methods that at least partially resolve some of the afore-mentioned disadvantages.

### SUMMARY

In a first aspect, a method for manufacturing a unitary bumper beam assembly of a vehicle is provided. The method comprises providing a plurality of blanks, joining the blanks to form a combined blank, deforming the combined blank to form a bumper beam assembly, wherein the bumper beam assembly includes a bumper beam and a pedestrian beam and at least one bracket connecting the bumper beam to the pedestrian beam.

Joining the blanks to each other to form a combined blank and then deforming the combined blank, provides a light and resistant bumper beam assembly built in fewer steps. Joining the blanks together prior to deforming enables manufacturing of a bumper beam assembly with no or less heat affected zones, because welding operations after forming are reduced. Less heat affected zones reduce the risk of cracks in the case of an accident.

Brackets may herein be regarded as substantially vertical connectors for joining the bumper beam to the pedestrian beam.

In some examples, blanks from different material thickness and/or grades may be used in order to satisfy specific strength, anti-intrusion and energy absorption requirements and optimizing weight.

In some examples, the plurality of blanks comprises a bumper beam blank, a bracket blank, and a pedestrian beam blank. In some examples, the bumper beam blank may be made from an ultra high strength steel and the pedestrian beam blank may be made from a more ductile material than the bumper beam blank.

Throughout the present disclosure, a bumper beam blank may be regarded as a blank that is subsequently deformed to form the bumper beam. Similarly, the pedestrian beam blank, and the bracket blank may be regarded as blanks that are subsequently deformed to form the pedestrian beam and the bracket respectively.

A bumper beam blank may be a blank formed by one or more sub-blanks. A pedestrian beam blank may be a blank formed by one or more sub-blanks. The bumper beam blank and the pedestrian beam blank may be joined together by at least one bracket.

In some examples, deforming the combined blank to form a unitary bumper beam assembly comprises hot stamping the combined blank. Hot stamping is a process which allows suitable deformation of ultra high strength steel to form the complicated resulting structure of the unitary bumper beam assembly.

In some examples, deforming the combined blank may be done in a single operation. This may allow having an increase in strength of the bumper beam assembly while reducing thickness of the blanks and reducing the weaknesses of the final assembly. The combined blank may be formed prior to the deforming operation. The hazards caused by joints disappears, thereby reducing the risk of cracks in the unitary bumper beam assembly in crash events.

In a further aspect, a unitary bumper beam assembly as obtained by a method according to any of the examples herein described is provided.

### BRIEF DESCRIPTION OF THE DRAWINGS

Non-limiting examples of the present disclosure will be described in the following, with reference to the appended figures, in which:

FIG. 1 shows an example of a bumper beam assembly of a vehicle according to the state of the art;

FIG. 2 shows an example of a unitary bumper beam assembly of a vehicle;

FIG. 3 shows an example of a plurality of blanks prior to being joined to form a combined blank;

FIG. 4 shows an example of a schematic view of a combined blank formed by four joined blanks;

FIG. 5A shows an example of a unitary bumper beam assembly of a vehicle with a single bracket connecting the bumper beam to the pedestrian beam;

FIG. 5B shows another example of a unitary bumper beam assembly of a vehicle with two brackets connecting the bumper beam to the pedestrian beam;

FIG. 6 shows an example of an enlarged view of joined blanks after deforming in a unitary bumper beam assembly of a vehicle;

FIG. 7 shows an example of an alternative cross-section of the bumper beam;

FIG. 8 shows an example of a side view of a unitary bumper beam assembly;

FIG. 9A shows an example of a unitary bumper beam assembly of a vehicle comprising supports for auxiliary systems;

FIG. 9B shows an example of the supports for auxiliary systems in a unitary bumper beam assembly; and

FIG. 10 is a flow chart of a method for manufacturing a unitary bumper beam assembly of a vehicle.

The figures refer to example implementations and may only be used as an aid for understanding the claimed subject matter, not for limiting it in any sense.

### DETAILED DESCRIPTION OF EXAMPLES

In these figures, the same reference signs have been used to designate matching elements.

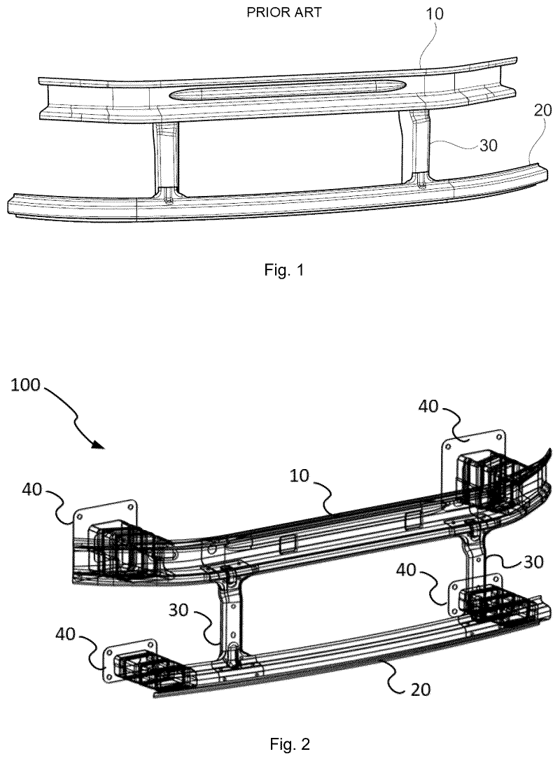

FIG. 1 shows a bumper beam assembly of the state of the art. This bumper beam assembly comprises a bumper beam 10, a pedestrian beam 20 and two connecting brackets 30. This bumper beam assembly is made from four independent components which are subsequently welded together. The bumper beam 10 may be regarded as the main component of the bumper designed to absorb impacts. The bumper beam 10 may be made from an UHSS in a hot stamping process. In examples, the bumper beam 10 may include one or more softer zones, i.e. zones of lower mechanical strength than other parts of the bumper beam to increase energy absorption and control the kinematics of deformation in case of an impact.

The pedestrian beam 20 generally does not require the same strength and stiffness and may be made by cold forming. E.g. a dual phase steel or complex phase steel might be used. The pedestrian beam 20 is generally configured to avoid or reduce lower leg injuries in case of collision with a pedestrian.

A grille (not shown) i.e. a cover of an opening in the vehicle for air inlet or outlet, may generally be arranged between the bumper beam 10 and the pedestrian beam 20. The arrangement of the brackets 30 may be adapted to the desired shape of the grille.

FIG. 2 schematically represents a unitary bumper beam assembly 100 of a vehicle according to an example of the present disclosure. The unitary bumper beam assembly 100 comprises a bumper beam 10, a pedestrian beam 20 and at least a connecting bracket 30. The bumper beam 10 and the pedestrian beam 20 are connected to the vehicle through crash boxes 40.

In this example, crash boxes 40 are provided both for the bumper beam 10 and for the pedestrian beam 20. In other examples, crash boxes 40 are only provided for the bumper beam 10. The crash boxes 40 of the bumper beam 10 may be connected to rails of the vehicle framework.

In some examples, the unitary bumper beam assembly 100 may define a front crash management system of a vehicle, i.e. the assembly may be arranged at a front side of the vehicle and connected to front rails.

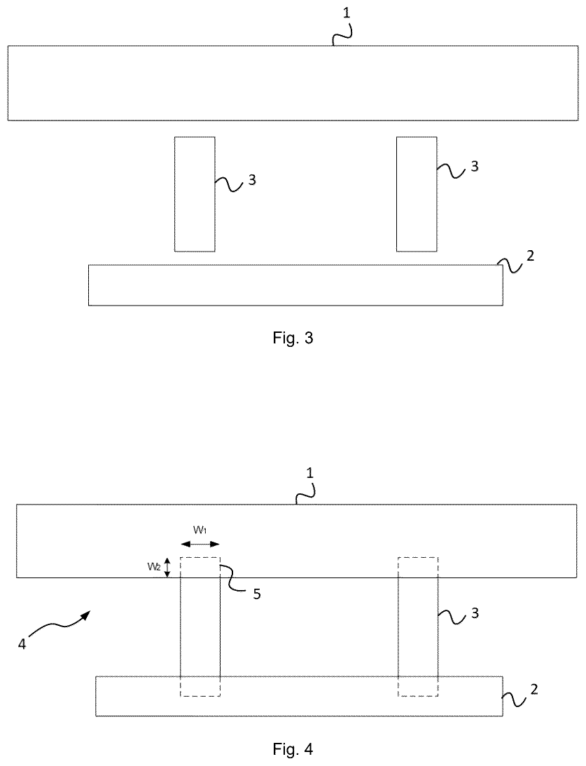

The unitary bumper beam assembly 100 may be made from a plurality of blanks in a single deforming process. As schematically illustrated in FIG. 3, the unitary bumper beam assembly 100 may be made from three blanks, a first blank 1, a second blank 2 and a third blank 3, wherein the first blank 1 may be a bumper beam blank 1, the second blank 2 may be a pedestrian beam blank 2 and the third blank 3 may be a bracket blank 3. The bumper beam blank 1 may be joined to the bracket blank 3, and the bracket blank 3 may be joined to the pedestrian beam blank 2. A combined blank 4 including the three blanks 1, 2, 3 may thus be formed as shown in FIG. 4. The blanks may be welded to each other, e.g. through laser welding or spot welding. In a subsequent step, the combined blank 4 may be heated and deformed.

In other examples, the bumper beam assembly 100 may be made from a first blank 1 and a second blank 2, wherein the first blank 1 may be a bumper beam blank 1 and the second blank 2 may be a pedestrian beam blank 2. In these examples, the first and/or the second blanks 1, 2 may include a portion of a blank that is to form a bracket 30.

In some embodiments, the bumper beam blank 1 may be formed by a single blank. In other examples, the bumper beam blank 1 may be formed by a plurality of blanks or sub-blanks, e.g. of different thicknesses and/or different materials. In these examples, the plurality of blanks forming the bumper beam blank 1 may be a Tailor Welded Blank (TWB). The TWB may be formed by joining the sub-blanks by edge-to-edge welding, wherein welding may comprise laser welding. In other examples, the plurality of blanks forming the bumper beam blank 1 may be joined by forming one or more overlapping regions formed by partially overlapping the blanks to each other. In these cases, any of laser welding, arc welding or spot welding may be used.

In some examples, the bumper beam blank 1 may comprise at least one perpendicular vertical part to form a (part of) a bracket 30. The perpendicular vertical part may be of a width that is sufficient for ensuring a functional and safe joint between the bumper beam blank 1 and the pedestrian beam blank 2.

In some embodiments, the pedestrian beam blank 2 is formed by a single blank. In other examples, the pedestrian beam blank 2 is formed by a plurality of blanks e.g. a tailor welded blank comprising sub-blanks of different thickness and/or different material.

In some examples, the pedestrian beam blank 2 may comprise at least one perpendicular vertical part. The perpendicular vertical part may be of a width that is sufficient for ensuring a functional and safe joint between the bumper beam blank 1 and the pedestrian beam blank 2, e.g. 10-15 cm.

As schematically illustrated in FIG. 4, the blanks forming the unitary bumper beam assembly 100 may be joined to form a combined blank 4. In an example, the combined blank 4 may be formed by joining the bumper beam blank 1 to the pedestrian beam blank 2 by at least a bracket blank 3. The bracket blank 3 may act as a substantially vertical connector between the bumper beam blank 1 and the pedestrian beam blank 2. The width W₁ of the bracket blank 3 may be e.g. of 8-20 cm, specifically 5-15 cm.

In some examples, joining the blanks comprises joining a first end of a bracket blank 3 to the bumper beam blank 1 and joining a second end of a bracket blank 3 to the pedestrian beam blank 2. The blanks may be welded to each other, e.g. through laser welding (specifically edge to edge) or spot welding. The region 5 where the blanks are joined is shown in FIG. 4. In some examples, the width W₂ of the overlapping region 5 between the bracket blank and the bumper beam blank (i.e. the extent to which the bracket blank extends into the bumper beam blank) may be e.g. from 2 cm-10 cm. Suitable dimensions for the overlapping region may be chosen taking into account weldability, and strength and stiffness requirements. A larger overlapping region means an increase in thickness over a larger area, and thus an increase in strength and stiffness locally in the bumper beam.

As may be seen in some of the examples hereinafter, the overlapping region may be such that it covers a part of a sidewall, or the whole height of the sidewall of the U-shape that is formed in the hot stamping process.

Similarly, overlapping regions may be formed between the bracket blank and the pedestrian beam blank.

Accordingly, one or more overlapping regions may be formed in the transition area between the bumper beam and the bracket beam and/or between the pedestrian beam and the bracket beam so as to reinforce these areas. The one or more overlapping regions may be formed within a horizontal part of the bumper beam and/or within a horizontal part of the pedestrian beam. The thickness achieved through the overlapping regions results in an increase in strength and stiffness in the transition area, leading to a more resistant bumper beam assembly.

In some examples, the bracket blank 3 may be joined to the bumper beam blank 1 on the open side of the hat-shaped cross-section. In other examples, the bracket blank 3 may be joined to the pedestrian beam blank 2 on the protruding part of the hat-shaped cross-section.

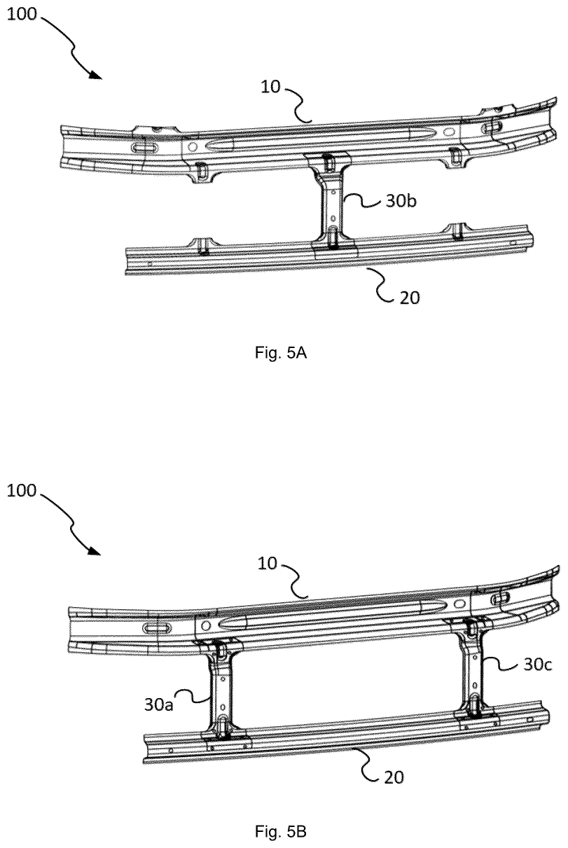

As schematically shown in FIG. 5A, in some examples, the unitary bumper beam assembly 100 comprises one bracket 30b connecting the bumper beam 10 to the pedestrian beam 20. In other examples, the unitary bumper beam assembly 100 comprises two or more brackets 30 connecting the bumper beam 10 to the pedestrian beam 20. FIG. 5B shows an example of a unitary bumper beam assembly 100 comprising two brackets 30a, 30c connecting the bumper beam 10 to the pedestrian beam 20. In other examples, the unitary bumper beam assembly 100 comprises three brackets connecting the bumper beam 10 to the pedestrian beam 20. Multiple possibilities are possible depending on the design of the unitary bumper beam assembly and of the vehicle.

In another example (not shown), the combined blank 4 may be formed by joining the bumper beam blank 1 including one or more vertical parts directly to the pedestrian beam blank 2, by joining the perpendicular vertical parts of the bumper beam blank 1 to the pedestrian beam blank 2. In another example, the combined blank 4 may be formed by joining the bumper beam blank 1 directly to the pedestrian beam blank 2, by joining at least one perpendicular vertical part of the pedestrian beam blank 2 directly to the bumper beam blank 1. Less joining steps may be required when forming the combined blank in this manner.

In some examples, the plurality of blanks that form the combined blank 4 may be made from different materials. At least some of the blanks may be made from ultra high strength steels (UHSS). In some examples, the bumper beam blank 1 may be made from ultra high strength steels. Boron steel, e.g. 22MnB5, or other steel compositions mentioned or referred to before may be suitable UHSS. These blanks, e.g. boron steel blanks, may comprise an aluminum silicon coating or zinc coating.

The plurality of blanks that form the combined blank 4 may comprise different material and/or thicknesses. In some examples, the pedestrian beam blank 2 may be made from a more ductile material than the bumper beam blank 1. For example, blanks of Usibor® (e.g. Usibor® 1500 or Usibor® 2000) and blanks or parts of the blanks of Ductibor® (e.g. Ductibor® 500 or Ductibor® 1000) may be used in the blanks that form the combined blank 4. Using these types of materials in hot forming and subsequent quenching processes leads to a predominantly martensitic structure in the Usibor® parts e.g in the bumper beam blank and a predominantly ferritic-perlitic structure in the Ductibor® parts e.g in the pedestrian beam blank and/or the bracket blank. According to these aspects, the properties of the unitary bumper beam assembly 100 may be tailored.

In some examples, the unitary bumper beam assembly 100 may comprise areas with different ultimate tensile strength according to any of the examples herein described. In some of these examples, the areas with different ultimate tensile strength may have a different microstructure.

In some examples, at least one of the blanks 1, 2, 3 may comprise areas with different ultimate tensile strengths. A blank may be composed of two different materials having different tensile strengths. The ductility of the areas with lower tensile strength is accordingly higher and therefore the energy absorption in a crash may be increased.

Different microstructures may be created in a hot formed bumper beam assembly. These different microstructures may be created by heating a combined blank 4 above the austenitization temperature and then controlling the cooling of the combined blank 4 during shaping the combined blank 4 to form a bumper beam assembly. The cooling of different areas of the combined blank 4 may be controlled by providing zones of the forming tool with heaters. Accordingly, the unitary bumper beam assembly 100 comprises zones with a predominantly martensitic structure and zones comprising ferrite, perlite or bainite or a mixed of thereof. Alternatively, a different microstructure, may be created by partially heating, e.g. using a laser beam, a portion of the unitary bumper beam assembly which has been press-hardened to change the predominantly martensitic structure to a structure containing ferrite and/or perlite and/or bainite and/or tempered martensite and a mixed of thereof. The tensile strength of the predominantly martensitic structure may be above 1400 MPa, and specifically above 1500 MPa, while the areas with a lower strength may have a tensile strength below 1000 MPa, specifically below 800 MPa, e.g. between 800 MPa and 500 MPa.

Thus, the bumper beam blank 1 may be made from a material which may be effective for absorbing energy during an impact. In some examples, the bumper beam blank 1 may be made at least from an ultra high strength steel.

The thickness of the bumper beam 10 may be of 1.5-3 mm. The bumper beam 10 may have an ultimate tensile strength of 1500-2000 MPa.

The pedestrian beam blank 2 may be made of a different material than the bumper beam blank 1. The pedestrian beam blank 2 may be made of a material and thickness which meet the pedestrian protection requirements. The thickness of the pedestrian beam 20 may be less than a thickness of the bumper beam 10. In an example, at least part of the pedestrian beam blank 2 is made from a more ductile material than the bumper beam blank 1.

The thickness of the pedestrian beam 20 may be of 1-2 mm. The pedestrian beam 20 may have an ultimate tensile strength of 500-1000 MPa.

The bracket blanks 3 may be made from a more ductile material than the bumper beam blank 2. This way, the brackets 30 may precisely control deformations in a crash. In other examples, the material of the bracket blanks 3 may be the same as the material from the bumper beam blank 1.

In other examples, the brackets 30 may be made from the same material as the pedestrian beam 20. The thickness of the bracket 30 may be of 1.5-3 mm. The bracket 30 may have an ultimate tensile strength of 500-1000 MPa.

In some examples, joining the blanks to each other comprises welding the blanks to each other. In some examples, the blanks may be welded by spot welding and/or laser welding. Joining the blanks before the deformation may make the joining easier due to the blanks being substantially flat at the moment of joining. Welding blanks prior to the deformation process by laser and/or spot welding may be efficient and precise.

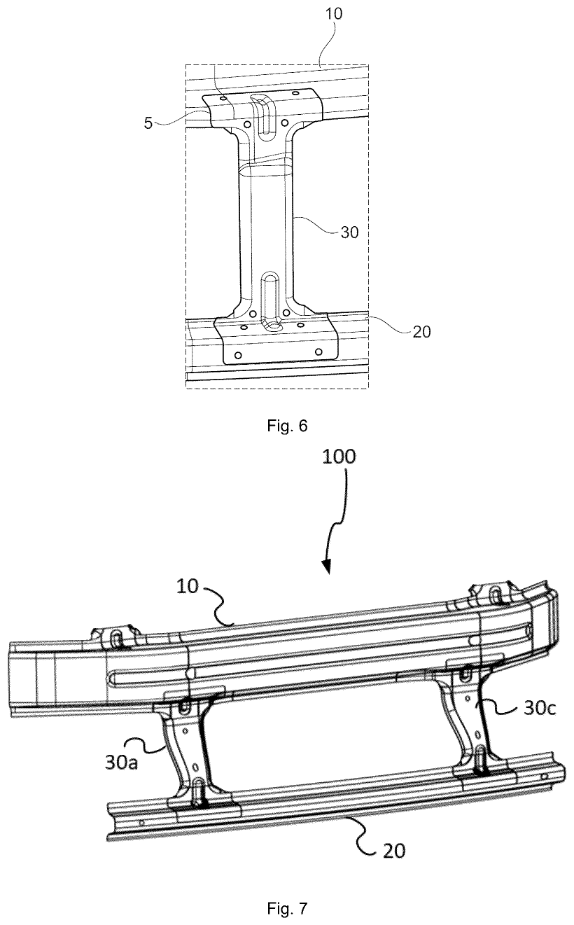

FIG. 6 schematically illustrates an example of joined blanks after deforming. In this example, the bracket blanks 3 may be joined to the bumper beam blank 1 and pedestrian beam blank 2 by overlapping one of the blanks with the other blank and using spot welding. In some examples, the overlapping region 5 between the bracket blank and the bumper beam blank and the pedestrian beam blank may be of a width of 2 cm-10 cm.

In other examples, joining the blanks to each other may comprise forming one or more overlapping regions formed by partially overlapping the blanks with each other. In other examples, the one or more overlapping regions may be formed by partially overlapping the bracket blank 3 with the bumper beam blank 1 and/or with the pedestrian beam blank 2. This may be done by laser or spot welding.

Joining the blanks may result in weld seams or spots, critical areas which in case of a car crash may be easily broken. Deforming after joining may ensure that weld seams or spots are not present between blanks, providing a unitary bumper beam assembly 100 more resistant. The hazards caused by this weld seams or spots disappears in the unitary bumper beam assembly 100, thereby reducing the risk of cracks in the unitary bumper beam assembly 100 in crash events.

Deforming the combined blank 4 to form the unitary bumper beam assembly 100 may comprise hot forming or hot stamping the combined blank 4.

In some examples, hot forming may comprise heating the combined blank above the austenitization temperature, and then forming the combined blank to create the unitary bumper beam assembly. In some examples, forming may comprise two or more forming steps. These forming steps may comprise for example shaping, trimming or cutting and may be made in a single multi-stage press. Examples of multi-stage presses are known from e.g. U.S. Pat. No. 9,492,859 B2 and WO 2016142367 A1.

Deforming may include hot forming, i.e. heating the combined blank in an oven, possibly above an austenization temperature, specifically above Ac3. After heating in the oven, the combined blank 4 may be transferred to a press in which the combined blank 4 is deformed to obtain the final shape of the unitary bumper beam assembly 100. During and immediately after forming, quenching may be carried out. In particular, the quenching may include cooling above a critical cooling rate so that a martensitic microstructure is obtained. In some examples, quenching may be avoided in selected portions of the bumper beam assembly.

In some examples, deforming is done in one single operation. Deforming the combined blank 4 may provide a unitary bumper beam assembly 100 with improved crash resistance and produced with less processes.

In some examples, deforming the combined blank 4 to form the unitary bumper beam assembly 100 comprises providing the bumper beam 10 and the pedestrian beam 20 with a hat-shaped cross-section for better supporting bending loads.

In some examples, the hat-shaped cross-section of the pedestrian beam 20 may be open on a first side and the hat-shaped cross-section of the bumper beam 10 may be open on a second side, as illustrated e.g in FIGS. 5A and 5B. In other examples the hat-shaped cross-section of the pedestrian beam 20 may be open on a first side and the hat-shaped cross-section of the bumper beam 10 may also be open on the first side, as shown in FIG. 7. At least one bracket 30 may connect the bumper beam 10 to the pedestrian beam 20.

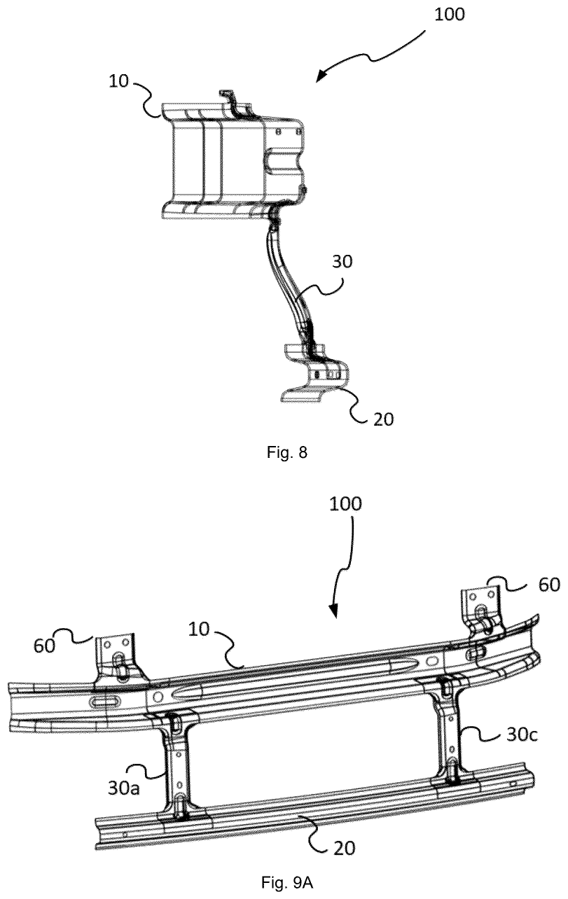

FIG. 8 represents a side view of the unitary bumper beam assembly 100, where the connection of the bumper beam 10 and the pedestrian beam 20 formed by the brackets 30 can be further appreciated.

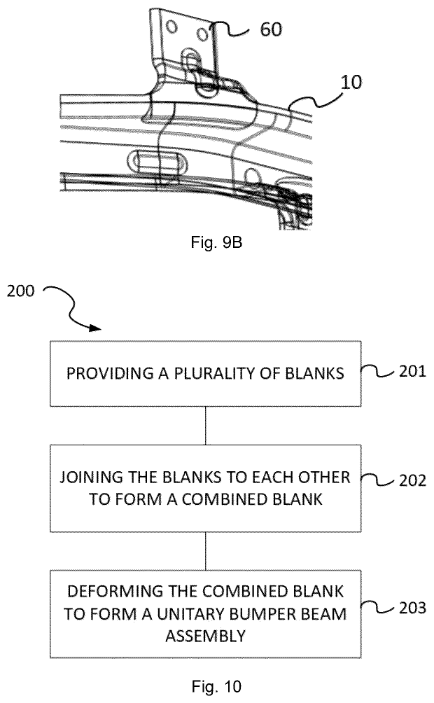

FIG. 9A schematically illustrates a further example of a bumper beam assembly 100. In the example of FIG. 9A, the unitary bumper beam assembly 100 may comprise a support 60 for an auxiliary system. In the example of FIG. 9A, two supports 60 are included. The size and position of the supports may vary depending on the specific requirements of the auxiliary system. The auxiliary system may comprise one or more sensors, e.g. proximity sensors for aiding during parking of the vehicle. The support 60 may be joined to the bumper beam blank before deforming the combined blank, i.e. it may form part of the combined blank 4 and the bumper beam assembly is again formed in a single deforming process, and specifically in a single forming step, e.g. through hot stamping. Addition of an auxiliary system may be ensured without adding weld seams or spots to the unitary bumper beam assembly 100 which may be under a risk of breaking in the case of an impact. Unnecessary critical areas may be avoided.

In some examples, the support 60 for an auxiliary system may comprise a thickness of 1.5-3 mm. In some examples, the support 60 for an auxiliary system may have an ultimate tensile strength of 500-1500 MPa. In other examples, the ultimate tensile strength of the support 60 for an auxiliary system may be of 500-1000 MPa.

The blanks for forming the supports 60 may be joined to the bumper beam blank through laser welding, e.g. an edge-to-edge welding. In another example, such as illustrated in FIG. 9B, the blanks for the supports 60 may be joined to the blank of the bumper beam by overlapping one of the blanks with the other blank and using spot welding.

FIG. 10 represents a flow chart of a method for manufacturing a unitary bumper beam assembly of a vehicle 200. The method comprises providing a plurality of blanks 201; joining the blanks to each other to form a combined blank 202; deforming the combined blank to form a unitary bumper beam assembly 203.

In some examples, providing a plurality of blanks 201 may comprise providing a bumper beam blank 1, a pedestrian beam blank 2 and a bracket blank 3. In some examples, the plurality of blanks that form the combined blank 4 may be made from different materials. In some examples, the bumper beam blank may be made from an ultra high strength steel and the pedestrian beam blank may be made from a more ductile material than the bumper beam blank.

In some examples, joining the blanks to each other to form a combined blank 202 may comprise welding the blanks to each other. The blanks may be welded by spot welding and/or laser welding.

Deforming the combined blank to form a unitary bumper beam assembly 203 may comprise hot forming or hot stamping the combined blank. Different microstructures may be created in a hot formed bumper beam assembly. These different microstructures may be created by heating a combined blank above the austenization temperature. In some examples, during and after forming, quenching may be carried out. Quenching may include cooling above a critical cooling rate so that a martensitic microstructure is obtained.

In some examples, different microstructures may be obtained by heating a combined blank above the austenization temperature and then controlling the cooling of the combined blank during shaping the combined blank to form a bumper beam assembly. In some examples quenching may be avoided in selected portions of the unitary bumper beam assembly.

In some examples, deforming the combined blank to form a unitary bumper beam assembly 203 may be done in a single operation. The unitary bumper beam assembly 100 formed by deforming the combined blank 203 includes a bumper beam 10, a pedestrian beam 20 and at least one bracket 30 connecting the bumper beam to the pedestrian beam.

For reasons of completeness, various aspects of the present disclosure are set out in the following numbered clauses:

Clause 1. A method for manufacturing a unitary bumper beam assembly (100) of a vehicle comprising:
providing a plurality of blanks (1, 2, 3);
joining the blanks to form a combined blank (4);
deforming the combined blank (4) to form the unitary bumper beam assembly (100), wherein the unitary bumper beam assembly (100) includes a bumper beam (10), a pedestrian beam (20) and at least one bracket (30) connecting the bumper beam to the pedestrian beam.

Clause 2. The method for manufacturing a unitary bumper beam assembly (100) according to clause 1, wherein joining the blanks comprises welding the blanks to each other.

Clause 3. The method for manufacturing a unitary bumper beam assembly (100) according to clause 2, wherein welding comprises resistance spot welding and/or laser welding.

Clause 4. The method for manufacturing a unitary bumper beam assembly (100) according to any of clauses 1-3, wherein deforming the combined blank (4) to form the unitary bumper beam assembly (100) comprises hot stamping the combined blank (4).

Clause 5. The method for manufacturing a unitary bumper beam assembly (100) according to any of clauses 1-4, wherein deforming is done in one single operation.

Clause 6. The method for manufacturing a unitary bumper beam assembly (100) according to any of clauses 1-4, wherein deforming is done in more than one operation.

Clause 7. The method for manufacturing a unitary bumper beam assembly (100) according to any of clauses 1-6, wherein the unitary bumper beam assembly (100) comprises two or more brackets (30) connecting the bumper beam (10) to the pedestrian beam (20).

Clause 8. The method according to any of clauses 1-7, wherein the plurality of blanks comprises a bumper beam blank (1) and a pedestrian beam blank (2).

Clause 9. The method according to clause 8, wherein the bumper beam blank (1) is joined directly to the pedestrian beam blank (2).

Clause 10. The method according to clause 8, wherein the plurality of blanks comprises a bumper beam blank (1), a bracket blank (3), and a pedestrian beam blank (2).

Clause 11. The method according to any of clauses 1-10, wherein joining the blanks comprises forming one or more overlapping regions formed by partially overlapping the blanks with each other.

Clause 12. The method according to clause 11, wherein the one or more overlapping regions are formed by partially overlapping the bracket blank with the bumper beam blank (1) and/or with the pedestrian beam blank (2).

Clause 13. The method according to any of clauses 1-12, wherein a thickness of the pedestrian beam (20) is less than a thickness of the bumper beam (10).

Clause 14. The method according to clause 8, wherein at least part of the pedestrian beam blank (2) is made from a more ductile material than the bumper beam blank (1).

Clause 15. The method according to clause 8, wherein the bumper beam blank (1) is made from an ultra high strength steel.

Clause 16. The method according to any of clauses 1-15, wherein the bumper beam (10) has an ultimate tensile strength of 1.200 MPa-2.200 MPa, specifically 1400-2000 MPa.

Clause 17. The method according to any of clauses 1-16, wherein the pedestrian beam (20) has an ultimate tensile strength of 500-1000 MPa, specifically 500-800 MPa.

Clause 18. The method according to any of clauses 1-17, wherein the unitary bumper beam assembly (100) comprises a support (60) for an auxiliary system, and optionally wherein the auxiliary system comprises one or more sensors.

Clause 19. The method according to clause 18, wherein the support (60) for an auxiliary system comprises a thickness of 1.5-3 mm.

Clause 20. The method according to clause 19, wherein the support (60) for an auxiliary system has an ultimate tensile strength of 500-1500 MPa, specifically 500-1.000 MPa.

Clause 21. The method according to any of clauses 1-20, wherein deforming the combined blank (4) to form the unitary bumper beam assembly (100), comprises providing the bumper beam (10) and the pedestrian beam (20) with a hat-shaped cross-section.

Clause 22. The method according to clause 21, wherein the hat-shaped cross-section of the pedestrian beam (20) is open on a first side, and wherein the hat-shaped cross-section of the bumper beam (10) is open on a second side and at least one bracket connects the bumper beam (10) to the pedestrian beam (20).

Clause 23. The method according to clause 21, wherein the hat-shaped cross-section of the pedestrian beam (20) is open on a first side, and wherein the hat-shaped cross-section of the bumper beam (10) is open on the first side and at least one bracket (30) connects the bumper beam (10) to the pedestrian beam (20).

Clause 24. The method according to any of clauses 1-22, wherein the deforming is performed in a multi-step press.

Clause 25. A unitary bumper beam assembly obtainable by a method according to any of clauses 1-24.

Clause 26. The unitary bumper beam assembly according to clause 25, wherein the unitary bumper beam assembly is a front bumper beam assembly.

Clause 27. A vehicle comprising the unitary bumper beam assembly according to clause 26.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. A method for manufacturing a unitary bumper beam assembly of a vehicle comprising:
providing a plurality of blanks;
joining the blanks to form a combined blank;
deforming the combined blank to form the unitary bumper beam assembly, wherein the unitary bumper beam assembly includes a bumper beam, a pedestrian beam and at least one bracket connecting the bumper beam to the pedestrian beam,
wherein the plurality of blanks comprises a bumper beam blank and a pedestrian beam blank, and
wherein joining the blanks comprises forming one or more overlapping regions formed by partially overlapping the blanks with each other.

2. The method for manufacturing a unitary bumper beam assembly according to claim 1, wherein the plurality of blanks further comprise, a bracket blank.

3. The method for manufacturing a unitary bumper beam assembly according to claim 2, wherein the one or more overlapping regions are formed by partially overlapping the bracket blank with the bumper beam blank and/or with the pedestrian beam blank.

4. The method for manufacturing a unitary bumper beam assembly according to claim 1, wherein joining the blanks comprises welding the blanks to each other.

5. The method for manufacturing a unitary bumper beam assembly according to claim 4, wherein welding comprises resistance spot welding and/or laser welding.

6. The method for manufacturing a unitary bumper beam assembly according to claim 1, wherein deforming the combined blank to form the unitary bumper beam assembly comprises hot stamping the combined blank.

7. The method for manufacturing a unitary bumper beam assembly according to claim 1, wherein deforming is done in one single operation.

8. The method for manufacturing a unitary bumper beam assembly according to claim 1, wherein the unitary bumper beam assembly comprises two or more brackets connecting the bumper beam to the pedestrian beam.

9. The method according to claim 1, wherein at least part of the pedestrian beam blank is made from a more ductile material than the bumper beam blank.

10. The method according to claim 1, wherein the bumper beam blank is made from an ultra high strength steel.

11. The method according to claim 1, wherein the unitary bumper beam assembly comprises a support for one or more sensors.

12. The method according to claim 1, wherein deforming the combined blank to form the unitary bumper beam assembly, comprises providing the bumper beam and the pedestrian beam with a hat-shaped cross-section.

13. The method according to claim 12, wherein the hat-shaped cross-section of the pedestrian beam is open on a first side, and wherein the hat-shaped cross-section of the bumper beam is open on a second side and the at least one bracket connects the bumper beam to the pedestrian beam.

14. A unitary bumper beam assembly obtainable by a method according to claim 1.

15. A vehicle comprising the unitary bumper beam assembly according to claim 14.

16. The method according to claim 12, wherein the hat-shaped cross-section of the pedestrian beam is open on a first side, and wherein the hat-shaped cross-section of the bumper beam is open on the first side and at least one bracket connects the bumper beam to the pedestrian beam.

17. The method according to claim 11, wherein the bumper beam has an ultimate tensile strength of 1.200 MPa-2.200 MPa.

18. The method according to claim 17, wherein the pedestrian beam has an ultimate tensile strength of 500-1000 MPa.

19. The method according to claim 18, wherein the support for the sensors has a thickness of 1.5-3 mm.

20. The method according to claim 19, wherein the support for the sensors has an ultimate tensile strength of 500-1500 MPa.
